(19) United States
(12) Patent Application Publication
(10) Pub. No.: US 2014/0150729 A1
(43) Pub. Date: Jun. 5, 2014

(54) NESTING SCRATCHER

(71) Applicant: WORLDWISE, INC., San Rafael, CA (US)

(72) Inventors: Sara Paculdo, San Francisco, CA (US); Regina Chern, Danville, CA (US)

(73) Assignee: WORLDWISE, INC., San Rafael, CA (US)

(21) Appl. No.: 13/693,997

(22) Filed: Dec. 4, 2012

(51) Int. Cl. A01K 15/02

(52) U.S. Cl. CPC A01K 15/024
USPC 119/706

(57) ABSTRACT

A cat scratcher in the form of a support having first and second sides and scratching media affixed to at least the first side thereof. The support has a first ramp, a first arc of curvature, a second ramp, a second arc of curvature and a third ramp, the first and second arcs of curvature having centers of curvature on opposite sides of the support, the arcs of curvature being less than 180 degrees.

### TECHNICAL FIELD

The present invention involves a nesting cat scratcher for introducing cat scratching surfaces to a domestic cat. A feature of the present invention is to provide a cat scratcher which can expose, in its preferred embodiment, multiple and diverse scratching surfaces to a cat while being configured to enhance nesting of individual scratchers to maximize shipping and display efficiencies.

### BACKGROUND OF THE INVENTION

It is well recognized that domestic cats crave scratching as part of their natural instinctive character. If a dedicated scratching surface is not provided, domestic cats will generally satisfy their need to scratch by turning to furniture, curtains and other articles which can be substantially damaged as a consequence. Oftentimes, pet cats will not only climb over furniture, especially upholstered chairs and sofas, but will use such furniture and carpeting to condition their claws through deliberate repeated clawing, pulling and tearing actions specifically with their forepaws. As noted, this clawing activity appears to be a natural impulse for cats and can be the source of great aggravation to the pet owner.

There are a number of commercially available items that are sold as cat scratchers. These include posts, pads and columns in a variety of diverse shapes all designed to encourage cat scratching and to maintain a cat's interest as an alternative to the destructive scratching of furniture, curtains and other household goods. Many of such products, although being successful in carrying out their intended mission, are difficult for retailers to stock and display for sale. Such items take up an inordinate amount of in-store shelf space resulting in the profitability of such items being less attractive.

In addition, as manufacturing has shifted to remote locations where labor costs are less than those in this country, the delivery of relatively low cost items, usually by containers shipped from Asia, has become a larger component of product pricing. This is particularly true as it pertains to the manufacture of non-technical, relatively low end products which rely upon unskilled labor-intensive operations. Further, retailers have become increasingly cost conscious necessitating the need to maximize shelf space. Products which assume a significant footprint at retail are at a competitive disadvantage.

Applicant had previously developed a cat scratcher as shown in FIGS. 1 and 2. Cat scratcher 10 includes two arcs of curvature 11 and 12 having radial centers 13 and 14, respectively. Each arc of curvature is approximately 180 degrees as shown noting that one or more fields of scratching media would be applied to first surface 15 noting further that area 16, being somewhat tunnel like, provides a space for seclusion.

Because of the nonlinear shape of scratcher 10, it has proven to be quite popular with pet owners and their cats. However, shipment and display of such products is less than ideal. In this regard, reference is made to FIG. 2.

In turning to FIG. 2, cat scratchers 21, 22 and 23 are shown stacked as during containerized transoceanic shipment to local retailers and as displayed for domestic sales. As noted, due to the 180 degree arcs of curvature, nesting of cat scratchers 21, 22 and 23 is not ideal resulting in inefficiencies and resulting higher costs.

It is thus an object of the present invention to provide a nesting cat scratcher which, due to its geometry, creates all of the advantages of the prior art while improving shipping and display efficiencies enhancing the profitability of such items.

These and further objects will be more readily apparent when considering the following disclosure and appended claims.

### SUMMARY OF THE INVENTION

A cat scratcher in the form of a support having first and second sides and scratching media affixed to at least the first side thereof. The support has a first ramp, a first arc of curvature, a second ramp, a second arc of curvature and a third ramp, the first and second arcs of curvature having centers of curvature on opposite sides of the support, the arcs of curvature being less than 180 degrees.

### BRIEF DESCRIPTION OF THE FIGURES

FIG. 1 is a side view of a cat scratcher of the prior art.

FIG. 2 is a side view of the stacking of multiple cat scratchers of FIG. 1.

FIG. 3 is a side perspective view of the cat scratcher of the present invention.

FIG. 4 is a second embodiment of the cat scratcher of the present invention.

FIG. 5 is a side view of the cat scratcher of the present invention.

FIG. 6 is a side view depicting the stacking of multiple cat scratchers of the present invention.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

As noted previously, the cat scratcher of the prior art as depicted in FIGS. 1 and 2, although offering a suitable scratching experience its geometry unduly adds to the cost of such a product because, as specifically noted in FIG. 2, multiple units do not readily stack in a compact fashion thus increasing shipping and display costs. By contrast, the present invention addresses this issue without lessoning a cat's experience in employing such a device.

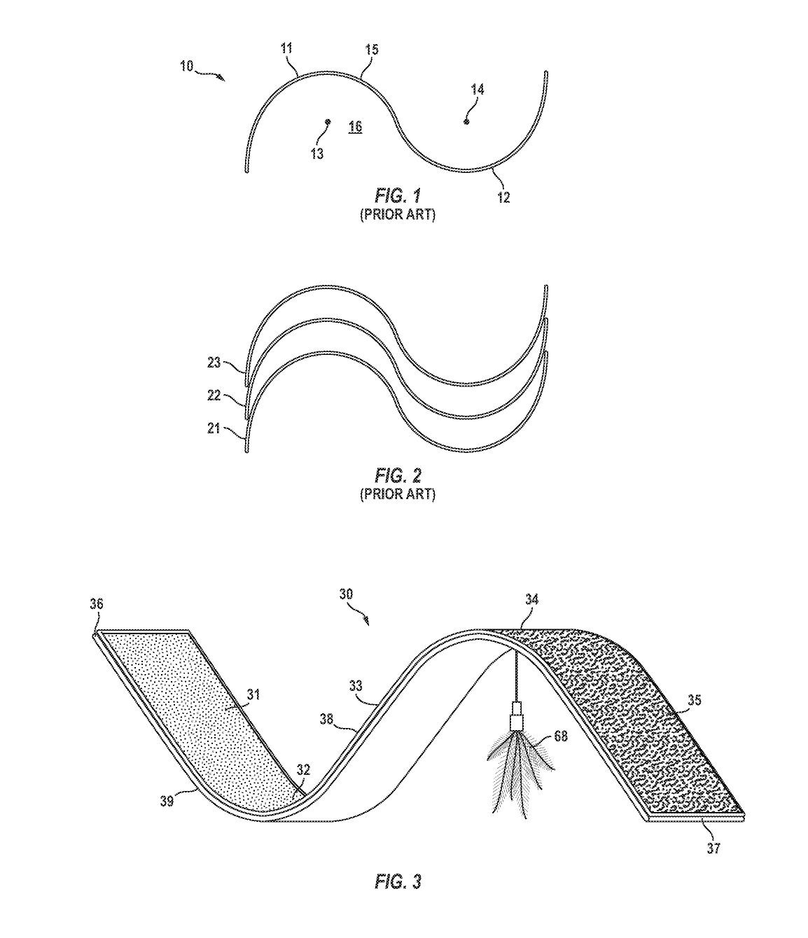

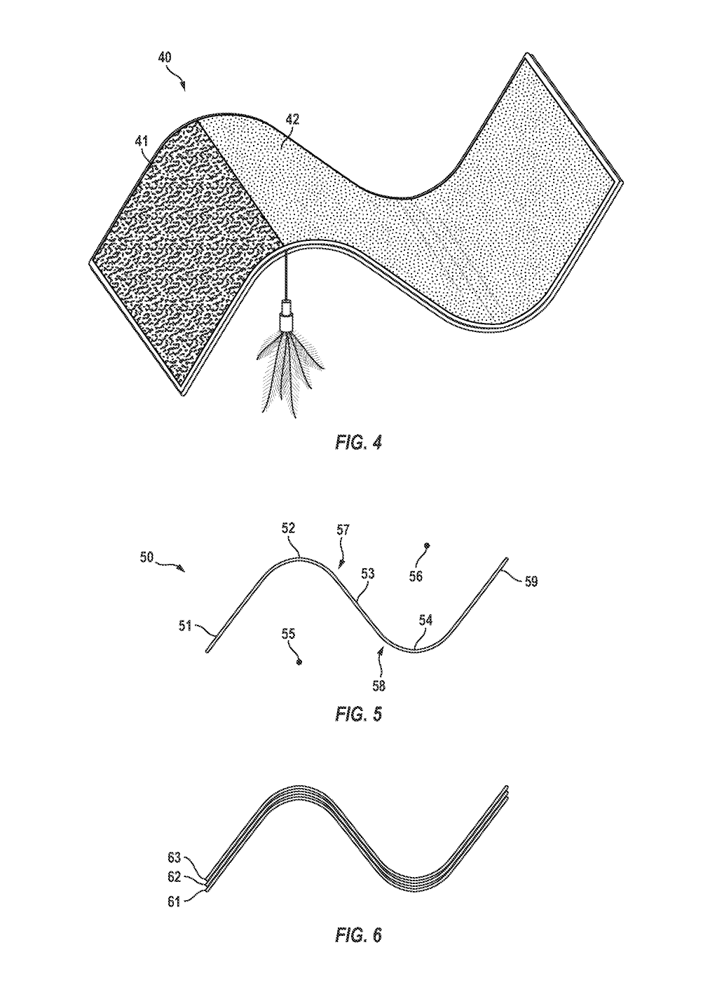

The contrast between the present invention and the prior art can be most readily appreciated when considering FIGS. 5 and 6 in comparison to FIGS. 1 and 2. As noted, FIG. 1 depicts a cat scratcher having a first curved surface 11 and a second curved surface 12, their respective centers of curvature being shown as radial centers 13 and 14. The arcs of curvature of curved surfaces 11 and 12, as depicted, are approximately 180 degrees measured from radial centers 13 and 14. Scratching media can be placed upon surface 15 best visualized by referring to FIGS. 3 and 4. A tunnel created in space 16 provides solitude for the using pet.

By comparison, as noted in FIG. 5, cat scratcher 50 comprises a support having first side 57 and second side 58 and a scratching media affixed to at least first side 57 as depicted in FIGS. 3 and 4. Cat scratcher 50 comprises first ramp 51, first arc of curvature 52, second ramp 53, second arc of curvature 54 and third ramp 59. First and second arcs of curvature having centers of curvature 55 and 56, respectively, these arcs of curvature being less than 180 degrees and more preferable less than 120 degrees and most preferably less than 90 degrees. By providing such a geometry, as noted in reference to FIG. 6, cat scratchers 61, 62 and 63 compactly stack when one is placed atop another, the appreciation for the compactness of such stacking being in direct comparison with the stacking of prior scratchers shown in FIG. 2.

In reference to FIG. 3, scratcher 30 is shown as composed of support 39 having first end 36, first ramp 31 extending from first end 36 to first arc of curvature 32 whereupon support 39 transitions into second ramp 33 and into second arc of curvature 34 terminating in third ramp 35 at end 37. Scratching media 38 is contiguous with support 39 and thus conforms to its geometry. Optional attractant 68 is hung from second arc of curvature 34 to complete the scratcher. FIG. 4 is similar to the scratcher of FIG. 3, the distinction being that scratcher 40 is shown to present two different scratching surfaces 41 and 42 (sisal and carpet) to the pet in order to increase interest in this device.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

1. A cat scratcher comprising a support and scratching media fixed to at least the first side thereof, said support comprising a first ramp, a first arc of curvature, second ramp, second arc of curvature and a third ramp, said first and second arcs of curvature having centers of curvature on opposite sides of said support, said arcs of curvature being less than 180 degrees.

2. The cat scratcher of claim 1 wherein said arcs of curvature are less than 120 degrees.

3. The cat scratcher of claim 1 wherein said arcs of curvature are less than 90 degrees.

4. The cat scratcher of claim 1 wherein said scratching media comprise at least two different scratching surfaces affixed to said first side of said support.

5. A cat scratcher comprising a rigid support having a first side and a second side and scratching media affixed to at least the first side thereof, said support comprising a first ramp extending from a first edge of said support to a first arc of curvature, a first arc of curvature extending from said first ramp to a second ramp, a second ramp extending from said first arc of curvature to a second arc of curvature, a second arc of curvature extending from said second ramp to a third ramp, a third ramp extending from said second arc of curvature to a second edge of said support, each arc of curvature having a center of curvature said arcs of curvature being on opposite sides of said support, said arcs of curvature being less than 180 degrees.

6. The cat scratcher of claim 5 wherein said arcs of curvature are less than 120 degrees.

7. The cat scratcher of claim 5 wherein said arcs of curvature are less than 90 degrees.

8. The cat scratcher of claim 5 wherein said scratching media comprise at least two different scratching surfaces affixed to said first side of said support.

9. The cat scratcher of claim 1 wherein said scratching media is contiguous to the first side of said support and conforms to the geometry of said support.
